(19) United States
(12) Patent Application Publication
(10) Pub. No.: US 2025/0043545 A1
(43) Pub. Date: Feb. 6, 2025

(54) WORK TOOL ENGAGEMENT SYSTEM AND METHOD FOR UTILITY VEHICLES

(71) Applicant: Deere & Company, Moline, IL (US)

(72) Inventors: David A. Veasy, Dubuque, IA (US); Craig A. Christofferson, Dubuque, IA (US)

(21) Appl. No.: 18/426,471

(22) Filed: Jan. 30, 2024

Related U.S. Application Data
(60) Provisional application No. 63/516,750, filed on Jul. 31, 2023.

(51) Int. Cl. E02F 9/26

(52) U.S. Cl. CPC E02F 9/261

(57) ABSTRACT

In accordance with an example embodiment, a utility vehicle comprising a main frame; a work tool configured to move relative to the main frame to move a material on a surface; a ground sensing apparatus proximate the work tool, wherein the ground sensing apparatus is configured to detect contact between the work tool and the surface; a non-transitory computer-readable memory storing operation information; and an electronic processor configured to: receive image data captured by the ground sensing apparatus as the work tool passes over the surface, and determine if the work tool is in contact with the surface based on the image data.

### TECHNICAL FIELD

The present disclosure generally relates to a utility vehicle. An embodiment of the present disclosure relates to work tool engagement system for utility vehicles.

### BACKGROUND

Utility vehicles, such as motor graders, bulldozers, crawlers, feller bunchers, scrapers, excavators, skid and track loaders often use a blade to move material. While operating the utility vehicle, the position of the operator with respect to the work tool can make it difficult to know if the work tool is moving material (e.g., in contact with a surface/material) at any given time. This is especially true during grading operations or other precision maneuvers.

### SUMMARY

Various aspects of examples of the present disclosure are set out in the claims.

According to a first aspect of the present disclosure, utility vehicle comprising a main frame; a work tool configured to move relative to the main frame to move a material on a surface; a ground sensing apparatus proximate the work tool, wherein the ground sensing apparatus is configured to detect contact between the work tool and the surface; a non-transitory computer-readable memory storing operation information; and an electronic processor configured to: receive image data captured by the ground sensing apparatus as the work tool passes over the surface, and determine if the work tool is in contact with the surface based on the image data.

According to a second aspect of the present disclosure, a grade monitoring system for a work vehicle that operates on a surface, the control system comprising a work tool configured to move relative to a main frame to move a material on a surface; a ground sensing apparatus proximate the work tool, wherein the ground sensing apparatus is configured to detect contact between the work tool and the surface; a non-transitory computer-readable memory storing operation information; and an electronic processor configured to: receive image data captured by the ground sensing apparatus coupled with the work tool as the work tool passes over the surface, determine if the work tool is in contact with the surface based on the image data, and generate, based on the image data, as built data for the surface after the work tool has passed over the surface.

According to a third aspect of the present disclosure, a method of operating a utility vehicle, the method comprising moving a work tool over a surface; receiving, by a processor, image data captured by the ground sensing apparatus, determining, by the processor, if the work tool is in contact with the surface based on the image data, wherein the as built data is based on the image data, and generating, by the processor, as built data for the surface after the work tool has passed over the surface.

The above and other features will become apparent from the following description and accompanying drawings.

### BRIEF DESCRIPTION OF THE DRAWINGS

The detailed description of the drawings refers to the accompanying figures in which:

FIG. 1 is a side view of a utility vehicle with a blade, consistent with embodiments of the present disclosure;

FIG. 2 is a side view of a utility vehicle with a ground sensing apparatus proximate a work tool, consistent with embodiments of the present disclosure;

FIG. 3A-C are side views of a utility vehicle with the work tool of a utility vehicle moving material across a surface, consistent with embodiments of the present disclosure;

FIG. 4 is a representative view of a display, showing an image with the position of the blade relative to the surface being graded, consistent with embodiments of the present disclosure;

FIG. 5 is a schematic showing a work tool engagement system for a utility vehicle, consistent with embodiments of the present disclosure; and

FIG. 6 is a flow diagram of a method for operating a utility vehicle, consistent with embodiments of the present disclosure.

Like reference numerals are used to indicate like elements throughout the several figures.

### DETAILED DESCRIPTION

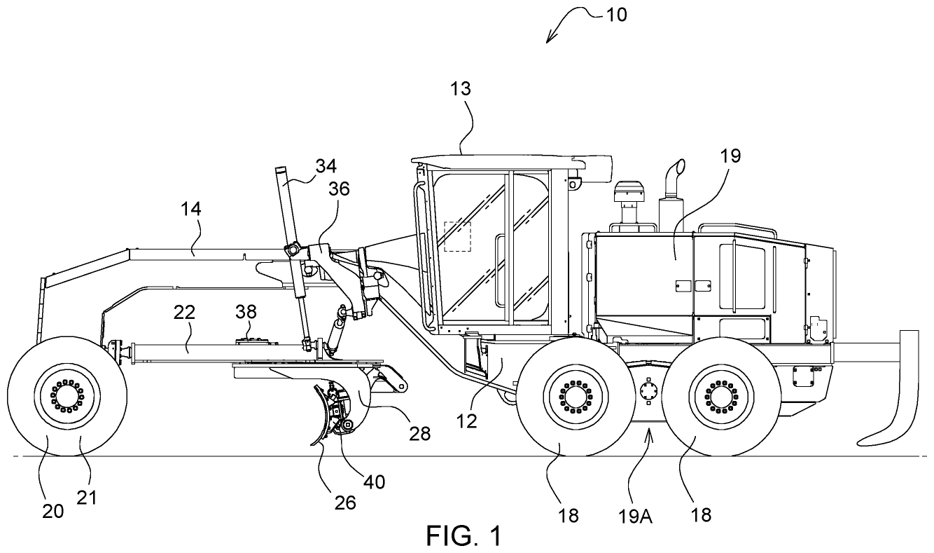

At least one example embodiment of the subject matter of this disclosure is understood by referring to FIGS. 1 through 6 of the drawings.

While the present disclosure has been illustrated and described in detail in the drawings and foregoing description, such illustration and description is not restrictive in character, it being understood that illustrative embodiment(s) have been shown and described and that all changes and modifications that come within the spirit of the present disclosure are desired to be protected. Alternative embodiments of the present disclosure may not include all of the features described yet still benefit from at least some of the advantages of such features. Those of ordinary skill in the art may devise their own implementations that incorporate one or more of the features of the present disclosure and fall within the spirit and scope of the appended claims.

While operating a utility vehicle, the position of the operator with respect to the work tool can make it difficult to see the amount of material being moved by the work tool at any given time. This can be challenging for a number of reasons. For example, when the operator wants to adjust for changes in terrain or other reasons, being able to see how much and/or how little material is accumulating in or on the work tool can be beneficial. With a limited view, the operator is slower to react to changes in conditions. Having an improved view of the material being moved by the blade could improve performance and accuracy of maneuvers being done by the utility vehicle.

FIG. 1 is a side view of a utility vehicle with a blade, consistent with embodiments of the present disclosure. FIG. 1 illustrates a utility vehicle in the form of a motor grader 10. Although a utility vehicle is illustrated and described as the motor grader 10, the utility vehicle may include, for example, bulldozers, crawlers, rollers, compactors, excavators, loaders, scrapers, excavators, skid and compact track loaders, milling machines, or any other utility vehicle that uses a work tool (e.g., a bucket, a blade, a moldboard, etc.) to move material, including those performing grading operators.

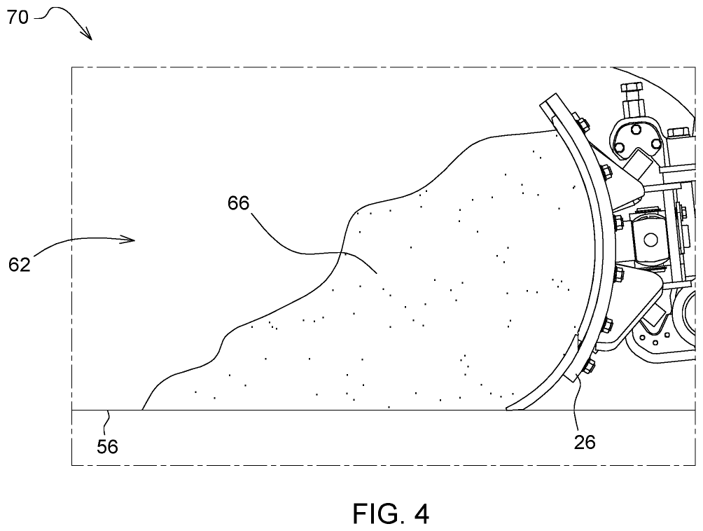

Motor grader 10 includes a main frame 12 and an articulated frame 14 which is pivotable with respect to main frame 12. Operator cab 13 is mounted atop articulated frame 14. Operator cab 13 includes operator controls, such as display unit 70 shown in FIG. 4 and described in detail below, such that a human operator can control the vehicle 10.

The articulated frame 14 includes a moldboard 26 (e.g., a blade) mounted thereto. The blade 26 is configured for spreading, leveling, or otherwise moving earthen or other material. In order to facilitate such operations, blade 26 is mounted to frame 14 such that blade 26 is selectively moveable in a number of directions. A draft frame 22 is coupled to articulated frame 14 toward the front via a ball-and-socket joint. A circle frame 28 is coupled to the draft frame 22 to rotate relative thereto by use of a circle drive 38 mounted to the draft frame 22. A tilt frame 40 holds the blade 26 and is coupled pivotally to the circle frame 28 for pivotal movement of the tilt frame 40 and the blade 26 held thereby relative to the circle frame 28 about a tilt axis by use of a tilt cylinder (not shown in FIG. 1).

The tilt cylinder is connected to circle frame 28 and tilt frame 40, such that actuation of tilt cylinder 30 changes the pitch of tilt frame 40 (and thus the moldboard 26) relative to circle frame 28. Left and right blade-lift cylinders 34 (i.e., hydraulic lift cylinders) are connected to saddle 36 (which in turn is fixed to articulation frame 14) and draft frame 22 such that actuation of left and right blade lift cylinders 34 raises and lowers the sides of draft frame 22, and thus the moldboard 26, relative to articulation frame 14

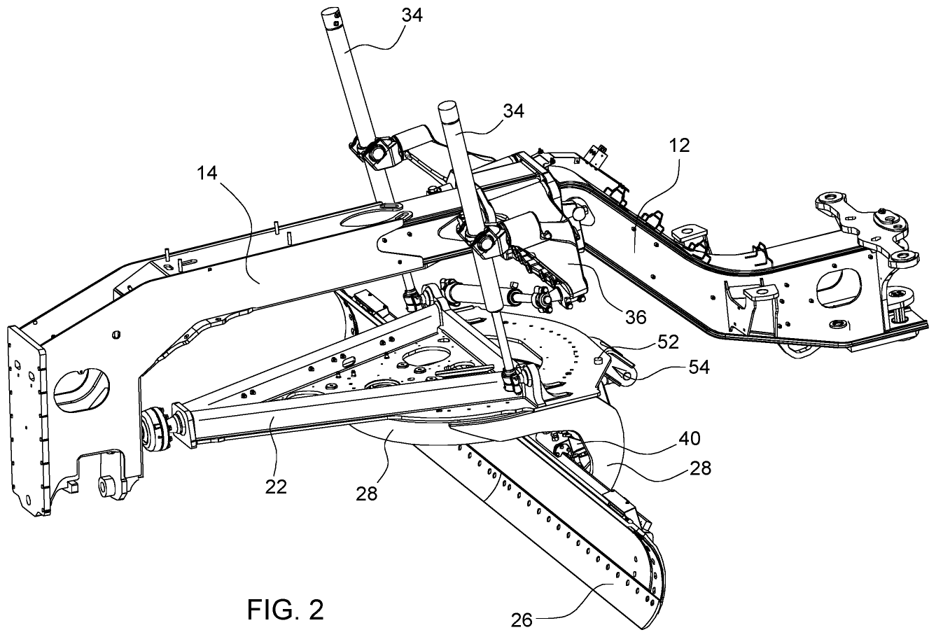

FIG. 2 is a side view of the utility vehicle of FIG. 1 with a ground sensing apparatus proximate a work tool, consistent with embodiments of the present disclosure. The utility vehicle 10 can include a ground sensing apparatus 50. The ground sensing apparatus 50 can be coupled with, for example, the main frame 12 or other location (e.g., under the operator cab 13 or on the articulated frame 14, with the circle frame 28, etc.) at a first position 54, where the first position 54 is rearward of the blade 26 (i.e., behind the blade 26; closer to the rear wheels 18). The position of the ground sensing apparatus 50 can be any suitable location on the work tool or proximate the work tool, on the main frame 12, the circle frame 28, the tilt frame 40, or other location on the work vehicle 10. The ground sensing apparatus 50 can be positioned to view the back (i.e., the side closer to the rear wheels 18) of the blade 26 and a surface 56 proximate the blade 26 (e.g., the surface that the blade 26 just passed over or graded).

The ground sensing apparatus 50 can detect the ground surface location with respect to the blade 26. For example, the ground sensing apparatus 50 can detect if the blade 26 is contacting the surface to achieve a desired grade of the surface 56 or if the blade 26 is not contacting the surface 56.

For example, upcoming terrain can include high points (e.g., mounds, piles, rises, etc.) and low points (e.g., holes, depressions, etc.). The blade 26, when set to a desired position to generate a grade, will remove material from the high points and lower them to the grade, while attempting to fill in the low points with material picked up from the high points. In some instances, there may not be enough material being carried by the blade 26 to fill in a low point, which will leave a low point (although, it may or may not be as low) after the blade 26 has passed over. This low point will cause an actual grade (i.e., as built grade) to differ from the desired grade (i.e., target grade, planned grade, grade control grade, etc.).

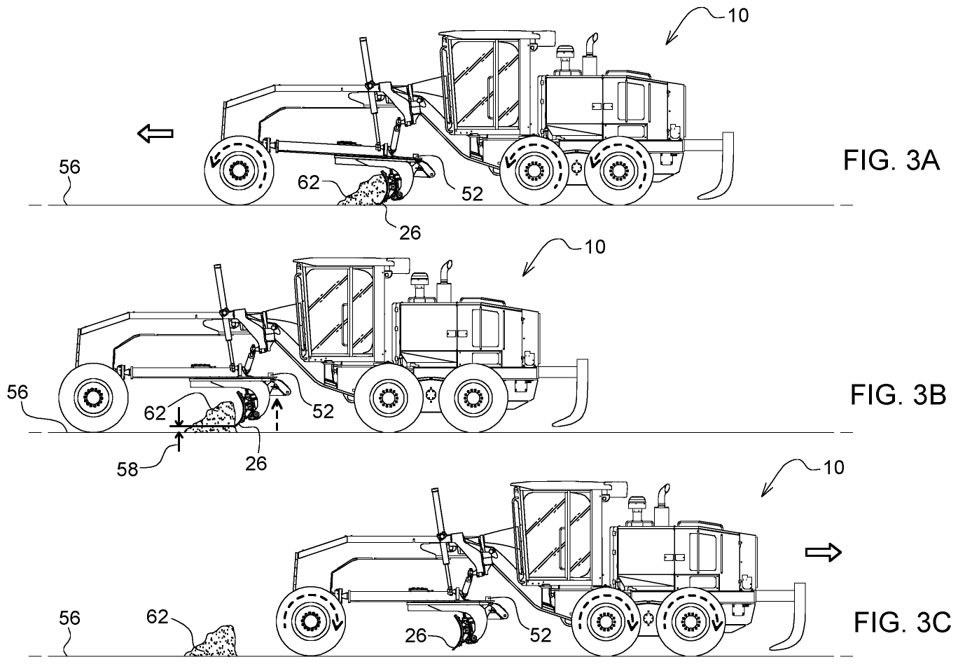

FIGS. 3A-C are side views of a utility vehicle with the work tool of a utility vehicle moving material across a surface, consistent with embodiments of the present disclosure. As the utility vehicle 10 moves, the work tool 26 can be used to move material 66 (e.g., dirt, gravel, etc.) to shape the surface 56 to a target grade 62. The amount of material 66 that is collected by the blade 26 can vary, depending on, for example, the type of material, the height of the work tool, the angle of the work tool, the speed of the utility vehicle, weather conditions, material conditions, and other similar parameters.

As the material 66 builds up along the work tool 26, it can be spread along the surface 56 to achieve the target grade 62. In some areas of the surface 56, a high point can be knocked down (i.e., leveled, smoothed out, etc.) as the work tool 26 moves across the surface 56, or a low point can be filled in by the material 66 being carried by the blade 26. However, there can be areas along the surface 56 that are not graded to the target grade 62. For example, there may be low points that may not be filled on that pass, causing an as built grade to differ from the target grade 62 or a piece of debris (e.g., a rock) may be carried along by the work tool 26, preventing the target grade 62 from being achieved.

The target grade 62 can be set in a grade control system where a utility vehicle can grade a surface to achieve target grade using grade control data. An as built grade is the surface after each pass of grading. In an ideal situation, the as built grade will match the target grade. However, there can be instances where the as built grade deviates from the target grade as described herein.

The as built grade can be determined as the utility vehicle 10 move the material 66 along the surface 56. The as built grade can differ from the target grade when the graded surface varies from the target grade (e.g., when a low point is not sufficiently filled in to match the as built grade with the target grade) after the blade 26 passes over the surface 56. The ground sensing apparatus 52 can capture an image of the graded surface (by capturing a series of images) and each image can be analyzed to determine the as built grade and generate as built data.

The as built grade data can be compared to the target grade data, and the comparison can be used to generate corrected grade data. The corrected grade data can be helpful when evaluating next steps in grading the surface as a deviation between the target grade to the as built grade will generally get worse with additional passes. Having the corrected grade data will allow for remedial work to address issues with the graded surface.

FIG. 4 is a representative view of a display, showing an image with the position of the blade relative to the surface being graded, consistent with embodiments of the present disclosure. The display 70 can include an image 62, which can include a position of the blade 26 relative to the surface 56 being graded. The display 70 can also include information related to the target grade and the as built grade.

For example, as the terrain drops away (i.e., dips down, drops, a hole, distance between the blade and the surface increases, etc.) the amount of material 66 moved by the blade 26 can decrease, resulting in less (or no) material 66 coming off an end of the blade 32.

Alternatively, as the terrain rises up (i.e., bumps up, a hump, a bump, a mound, a pile, distance between blade and the surface decreases, etc.) the amount of material 66 moved by the blade 26 can increase, resulting is more material coming off an end 26A or 26B (or both ends) of the blade 26.

The display 70 can display information about the grading monitoring system such as system status (e.g., system on, system off, etc.).

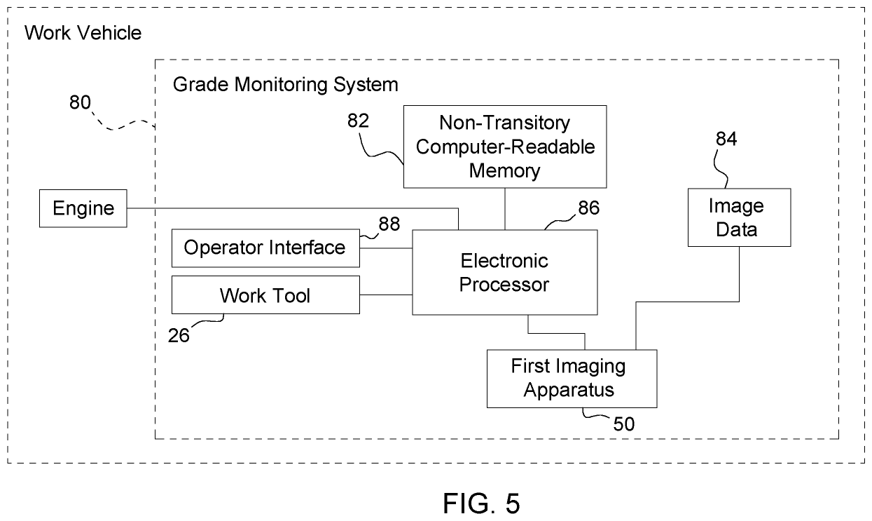

FIG. 5 is a schematic showing a grade monitoring system for a utility vehicle, consistent with embodiments of the present disclosure. The grade monitoring system 80 can include the ground sensing apparatus 50 coupled to the work vehicle 10. The ground sensing apparatus 50 is configured to capture a first image 58 (i.e., image data) that includes the blade 26 and the graded surface as described above. The ground sensing apparatus 50 may comprise a lidar sensor, a sonic sensor, an ultra-sonic sensor, or a camera. The ground sensing apparatus 50 can be used to obtain images (i.e., image data) that are evaluated to determine when the blade 26 is grading the surface to the grade control surface and/or when the graded surface deviates from the grade control surface.

The grade monitoring system 80 also has a non-transitory computer-readable memory 82 that stores image data 84. The non-transitory computer-readable memory 82 may comprise electronic memory, nonvolatile random-access memory, an optical storage device, a magnetic storage device, or another device for storing and accessing electronic data on any recordable, rewritable, or readable electronic, optical, or magnetic storage medium.

An electronic processor 86 is provided and configured to perform an operation by controllably adjusting a position of the work tool 26 relative to the utility vehicle 10 and capturing and processing images from the ground sensing apparatus 50 grade monitoring (and any additional imaging apparatuses). The electronic processor 86 may be arranged locally as part of the utility vehicle 10 or remotely at a remote processing center (not shown). In various embodiments, the electronic processor 86 may comprise a microprocessor, a microcontroller, a central processing unit, a programmable logic array, a programmable logic controller, or other suitable programmable circuitry that is adapted to perform data processing and/or system control operations. The electronic processor 86 executes or otherwise relies upon computer software applications, components, programs, objects, modules, or data structures, etc. Software routines resident in the included memory of the electronic processor 86 or other memory are executed in response to signals received.

The computer software applications, in other embodiments, may be located in the cloud. The executed software includes one or more specific applications, components, programs, objects, modules, or sequences of instructions typically referred to as “program code”. The program code includes one or more instructions located in memory and other storage devices which execute the instructions which are resident in memory, which are responsive to other instructions generated by the system, or which are provided by an operator interface 88 operated by the user (e.g., located in the operator cab or at a remote location). The electronic processor 86 is configured to execute the stored program instructions.

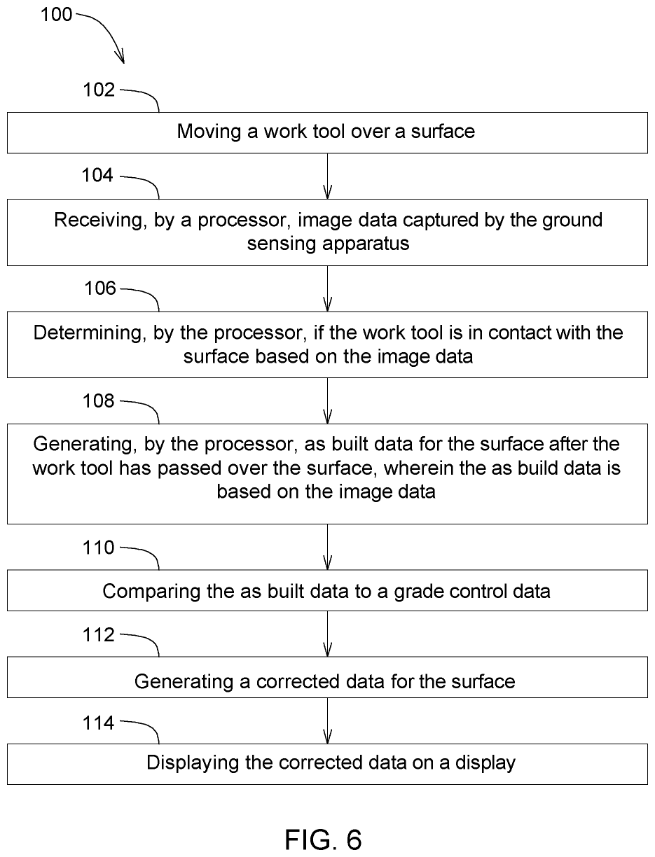

FIG. 6 is a flow diagram of a method for operating a utility vehicle, consistent with embodiments of the present disclosure. The method 100 for monitoring a grading operating by a utility vehicle can include the step 102 of moving a work tool over a surface, the step 104 of receiving, by a processor, image data captured by the ground sensing apparatus, the step 106 of determining, by the processor, if the work tool is in contact with the surface based on the image data; and the step 108 of generating, by the processor, as built data for the surface after the work tool has passed over the surface, wherein the as built data is based on the image data.

The method 100 can further comprise a step 110 of comparing the as built data to a grade control data and a step 112 of generating a corrected data for the surface. Based on analysis of the image, an estimate for the volume of material being moved by the work tool can be determined. The method 100 can further comprise the step 114 of displaying the corrected data on a display.

What is claimed is:

1. A utility vehicle comprising:
a main frame;
a work tool configured to move relative to the main frame to move a material on a surface;
a ground sensing apparatus proximate the work tool, wherein the ground sensing apparatus is configured to detect contact between the work tool and the surface;
a non-transitory computer-readable memory storing operation information; and
an electronic processor configured to:
receive image data captured by the ground sensing apparatus as the work tool passes over the surface,
determine if the work tool is in contact with the surface based on the image data.

2. The utility vehicle of claim 1, wherein the work tool comprises one or more of a blade, a bucket, a scraper, and a roller.

3. The utility vehicle of claim 1, wherein the ground sensing apparatus comprises a lidar sensor, a sonic sensor, an ultra-sonic sensor, or a camera.

4. The utility vehicle of claim 1, wherein the electronic processor is further configured to generate as built data for the surface after the work tool has passed over the surface.

5. The utility vehicle of claim 4, wherein the electronic processor is further configured to
compare the as built data for the surface to a grade control data for the surface, and
generate a corrected data for the surface.

6. The utility vehicle of claim 4, further comprising a display, and wherein the processor is further configured to display one or more of the surface, the grade control data, and the as built data on the display.

7. A grade monitoring system for a work vehicle that operates on a surface, the grade monitoring system comprising:
a work tool configured to move a material on the surface where the work tool is configured to move relative to a main frame;
a ground sensing apparatus proximate the work tool, wherein the ground sensing apparatus is configured to detect contact between the work tool and the surface;
a non-transitory computer-readable memory storing operation information; and
an electronic processor configured to:
receive image data captured by the ground sensing apparatus coupled with the work tool as the work tool passes over the surface,
determine if the work tool is in contact with the surface based on the image data,
generate, based on the image data, as built data for the surface after the work tool has passed over the surface.

8. The grade monitoring system of claim 7, wherein the work tool comprises one or more of a blade, a bucket, a scraper, and a roller.

9. The grade monitoring system of claim 7, wherein the ground sensing apparatus comprises a lidar sensor, a sonic sensor, an ultra-sonic sensor, or a camera.

10. The grade monitoring system of claim 7, wherein the electronic processor is further configured to
compare the as built data to a grade control data, and
generate a corrected data for the surface.

11. The grade monitoring system of claim 7, wherein the electronic processor is further configured to display the as built data on a display.

12. A method of operating a utility vehicle, the method comprising:
moving a work tool over a surface;
receiving, by a processor, image data captured by a ground sensing apparatus,
determining, by the processor, if the work tool is in contact with the surface based on the image data, wherein the as built data is based on the image data, and
generating, by the processor, as built data for the surface after the work tool has passed over the surface.

13. The method of claim 12, wherein the method further comprises displaying the as built data on a display.

14. The method of claim 12, further comprising
comparing the as built data to a grade control data, and
generating a corrected data for the surface.

15. The method of claim 14, further comprising
displaying the corrected data on a display.
